(19) United States
(12) Patent Application Publication
(10) Pub. No.: US 2026/0309989 A1
(43) Pub. Date: Oct. 8, 2026

(54) DISPLAY STRUCTURE

(71) Applicant: Dispelix OY, Espoo (FI)

(72) Inventors: Kalle VENTOLA, Joensuu (FI); Juuso OLKKONEN, Espoo (FI)

(21) Appl. No.: 19/479,613

(22) PCT Filed: Apr. 24, 2024
(86) PCT No.: PCT/FI2024/050190

§ 371 Date: Oct. 28, 2025

(30) Foreign Application Priority Data
May 3, 2023 (FI) 20235488

(51) Int. Cl. G02B 27/01; F21V 8/00; G02B 27/42

(52) U.S. Cl. CPC G02B 27/0172; G02B 6/0016; G02B 27/4272; G02B 2027/0178

(57) ABSTRACT

According to an embodiment, a display structure comprises: a waveguide (101); an in-coupling structure (102) on a first side (110) of the waveguide (101), comprising diffractive grating features and sub-wavelength grating features, and configured to receive light (104) comprising a first polarization and a second polarization, wherein the diffractive grating features are configured to couple at least part of the first polarization into the waveguide as in-coupled light (105), and wherein the sub-wavelength grating features are configured to make the diffractive grating features at least partially transparent to the second polarization; and a polarization manipulating grating (103) on a second side (111) of the waveguide (101) configured to receive at least a part of the in-coupled light (105), and to rotate the polarization of the in-coupled light (105), resulting in polarization-rotated in-coupled light (106), when the in-coupled light (105) is reflected from the second side (111) of the waveguide (101) back towards the first side (110) of the waveguide (101).

### TECHNICAL FIELD

The present disclosure relates to the field of diffractive optics, and more particularly to a display structure and a display device.

### BACKGROUND

In various optical applications, such as augmented reality (AR) applications, it is typically desirable to improve the optical efficiency of the used components. Further, image uniformity can be an important performance characteristic in AR applications.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object to provide a display structure and a display device. The foregoing and other objects are achieved by the features of the independent claims. Further implementation forms are apparent from the dependent claims, the description and the figures.

According to a first aspect, a display structure comprises: a waveguide; an in-coupling structure on a first side of the waveguide, comprising diffractive grating features and sub-wavelength grating features, and configured to receive light comprising a first polarization and a second polarization, wherein the diffractive grating features are configured to couple at least part of the first polarization into the waveguide as in-coupled light, and wherein the sub-wavelength grating features are configured to make the diffractive grating features at least partially transparent to the second polarization; and a polarization manipulating grating on a second side of the waveguide configured to receive at least a part of the in-coupled light, and to rotate the polarization of the in-coupled light, resulting in polarization-rotated in-coupled light, when the in-coupled light is reflected from the second side of the waveguide back towards the first side of the waveguide. The display structure can, for example, improve the optical efficiency of the display structure by reducing out-coupling via the in-coupling structure.

According to second aspect, a display device comprises a display structure according to the first aspect.

According to a third aspect, a structure for in-coupling a first polarization into a waveguide comprises a plurality of diffractive grating lines and a plurality sub-wavelength grating lines and configured to receive light comprising a first polarization and a second polarization, wherein the plurality of diffractive grating lines are configured to couple at least part of the first polarization into the waveguide as in-coupled light, the plurality of sub-wavelength grating lines are configured to make the plurality of diffractive grating lines at least partially transparent to the second polarization, and each grating line in the plurality of diffractive grating lines comprises an air gap.

Many of the attendant features will be more readily appreciated as they become better understood by reference to the following detailed description considered in connection with the accompanying drawings.

### DESCRIPTION OF THE DRAWINGS

In the following, embodiments are described in more detail with reference to the attached figures and drawings, in which:

FIG. 1 illustrates a schematic representation of a display structure according to an embodiment;

FIG. 2 illustrates a schematic representation of an in-coupling structure according to an embodiment;

FIG. 3 illustrates a schematic representation of an in-coupling structure according to another embodiment;

FIG. 4 illustrates a schematic representation of an in-coupling structure according to another embodiment;

FIG. 5 illustrates a schematic representation of a polarization manipulating grating according to an embodiment;

FIG. 6 illustrates a schematic representation of rotation between an in-coupling structure and a polarization manipulating grating according to an embodiment;

FIG. 7 illustrates a schematic representation of a waveguide according to an embodiment; and

FIG. 8 illustrates a schematic representation of a display device according to an embodiment.

In the following, identical reference signs refer to similar or at least functionally equivalent features.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

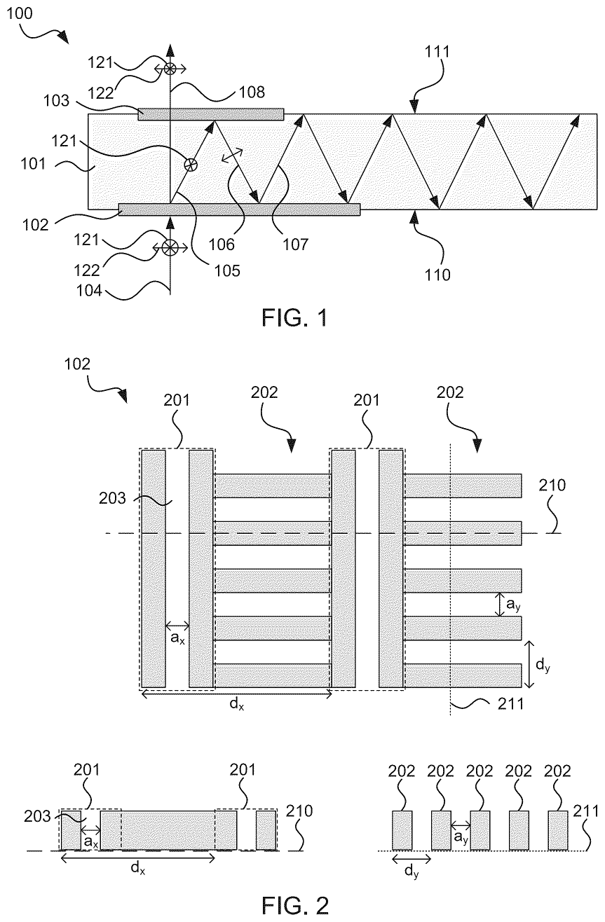

FIG. 1 illustrates a schematic representation of a display structure according to an embodiment.

According to an embodiment, a display structure 100 comprises a waveguide 101.

The waveguide 101 may comprise, for example, a substantially planar waveguide. Alternatively or additionally, the waveguide 101 may also comprise curved sections. For example, the waveguide 101 may correspond to a lens of augmented reality (AR) glasses. For example, the waveguide 101 may correspond to a layer of a lens of such AR glasses.

According to an embodiment, the display structure 100 further comprise an in-coupling structure 102 on a first side of the waveguide 110, comprising diffractive grating features and sub-wavelength grating features, and configured to receive light 104 comprising a first polarization 121 and a second polarization 122, wherein the diffractive grating features are configured to couple at least part of the first polarization 121 into the waveguide as in-coupled light 105, and wherein the sub-wavelength grating features are configured to make the diffractive grating features at least partially transparent to the second polarization 122.

The light 104 may also be referred to as input light, a plurality of input beams, a plurality of input light beams, a plurality of input rays, a plurality of input light rays, or similar.

Although the light 104, the in-coupled light 105 and various other light paths are illustrated using single light rays in FIG. 1, this is only for illustrative purposes. Any light disclosed herein may comprise, for example, a plurality of light beams that may propagate in various directions. For example, the light 104 may comprise a cone of light arriving to the in-coupling structure from a plurality of directions.

The light 104 may be generated by, for example, a scanner-based optical engine. The light 104 may represent an image generated by, for example, such an optical engine. Thus, the light 104 may also be referred to as, for example, image-bearing light, image-carrying light, image-bearing light rays/beams, image-carrying light rays/beams, or similar.

The first polarization 121 may also be referred to as a first linear polarization. The second polarization 122 may also be referred to as a second linear polarization.

According to an embodiment, the display structure further comprises a polarization manipulating grating 103 on a second side 111 of the waveguide 101 configured to receive at least a part of the in-coupled light 105, and to rotate the polarization of the in-coupled light 105, resulting in polarization-rotated in-coupled light 106, when the in-coupled light 105 is reflected from the second side 111 of the waveguide 101 back towards the first side 110 of the waveguide 101.

Herein, diffractive grating features may refer to grating features that have a spatial periodicity of the same order of magnitude or greater than the smallest wavelength of the light 104. Alternatively or additionally, sub-wavelength grating features may refer to grating features that have a spatial periodicity of the same order of magnitude or less than the smallest wavelength of visible light, such as less than 380 nanometres (nm).

Alternatively or additionally, diffractive grating features may refer to grating features that have a spatial periodicity, which, in the used incidence mounting, allows propagating diffraction orders, in either reflected or transmitted light, to emerge.

Alternatively or additionally, sub-wavelength grating features may refer to grating features that have a spatial periodicity, which, in the used incidence mounting, does not allow diffraction orders to emerge.

The sub-wavelength grating features may also be referred to as zeroth order grating features.

Herein, sub-wavelength grating features may refer to grating features that have a spatial periodicity smaller than the smallest wavelength of the light 104. Alternatively or additionally, sub-wavelength grating features may refer to grating features that have a spatial periodicity smaller than the smallest wavelength of visible light, such as smaller than 380 nm.

Since the diffractive grating features are configured to couple at least part of the first polarization 121 into the waveguide 101, some part of the first polarization 121 can also pass through the in-coupling structure 102 and/or the waveguide 101.

Since the sub-wavelength grating features can make the diffractive grating features at least partially transparent to the second polarization 122, at least a part of the second polarization can pass through the waveguide 101.

For example, as illustrated in the embodiment of FIG. 1, some light can pass through the in-coupling structure 102 and the waveguide 101. As illustrated in the embodiment of FIG. 1, the passed through light 108 may comprise less of the first polarization 121 than the light 104, since some of the first polarization 121 is coupled into the waveguide 101. Similarly, the passed through light 108 may also comprise less of the second polarization 122 than the light 104, since some of the second polarization 122 may be absorbed, scattered etc.

In an ideal situation, the diffractive grating features may couple all of the first polarization 121 into the waveguide 101 and the sub-wavelength grating features may make the diffractive grating features totally transparent to the second polarization 122. Thus, only the first polarization 121 is coupled into the waveguide 101 and all of the second polarization 122 passes through the waveguide 101. This may not be possible to implement in practice.

Since the polarization of the polarization-rotated in-coupled light 106 is rotated by the polarization manipulating grating 103, interaction between the polarization-rotated in-coupled light 106 and the in-coupling structure 102 can be reduced when the polarization-rotated in-coupled light 106 is reflected from the first side 110 of the waveguide 101. Thus, out-coupling of the polarization-rotated in-coupled light 106 due to diffraction caused by the in-coupling structure 102 can be reduced and optical efficiency of the display structure 100 can be improved.

According to an embodiment, the first polarization 121 and the second polarization 122 are substantially orthogonal.

For example, in the embodiment of FIG. 1, the first polarization 121 is perpendicular to the plane of FIG. 1 and the second polarization 122 is parallel with the plane of FIG. 1. The first polarization 121 may also be referred to as transverse electric (TE) polarization and the second polarization 122 may also be referred to as transverse magnetic (TM) polarization.

Herein TE polarization may refer to a polarization the electric field of which is substantially parallel with the diffractive grating lines of the diffractive grating features of the in-coupling structure 102. Similarly, TM polarization may refer to a polarization the magnetic field of which is substantially parallel with the diffractive grating lines of the diffractive grating features of the in-coupling structure 102.

Since the diffractive grating features are configured to couple at least part of the TE polarization into the waveguide 101 as the in-coupled light 105 and the sub-wavelength grating features are configured to make the diffractive grating features at least partially transparent to the TM polarization, more of the TE polarization is coupled into the waveguide than of the TM polarization. It may be desirable that all TE polarization is coupled into the waveguide 101 while none of the TM polarization is coupled into the waveguide 101.

Since the polarization manipulating grating 103 is configured to receive at least a part of the in-coupled light 105, and to rotate the polarization of the in-coupled light 105, resulting in the polarization-rotated in-coupled light 106, the polarization of the polarization-rotated in-coupled light 106 is rotated compared to the in-coupled light 105. For example, in the embodiment of FIG. 1, the TE polarization of the in-coupled light 105 is rotated into a TM polarization of the polarization-rotated in-coupled light 106. This is only an idealized example and the polarization of the in-coupled light 105 may be rotated in various other ways in practical implementations of the display device 100.

Since the sub-wavelength grating features are configured to make the diffractive grating features at least partially transparent to the TM polarization the TM polarization of the polarization-rotated in-coupled light 106 does not ideally interact with the in-coupling structure 102. Thus, unwanted out-coupling can be reduced.

The positioning of the in-coupling structure 102 illustrated in the embodiment of FIG. 1 is only exemplary and the in-coupling structure 102 may be positioned in various other ways. In some embodiments, the in-coupling structure 102 may be positioned on any surface of the waveguide 101. In other embodiments, the in-coupling structure 101 be positioned inside the waveguide 101.

The in-coupled light 105 can be guided inside the waveguide 101 via total internal reflection (TIR).

According to an embodiment, the in-coupling structure 102 is configured to diffract the light 104 via zeroth order and first order diffractions.

In any embodiment disclosed herein, the in-coupling structure 102 may comprise a reflective or a transmissive diffractive grating.

According to an embodiment, the in-coupling structure 102 and the polarization manipulating grating 103 are configured such that the diffractive grating features are at least partially transparent to the polarization-rotated in-coupled light 106. Thus, the in-coupling structure 102 may not out-couple the polarization-rotated in-coupled light 106 or the out-coupling of the polarization-rotated in-coupled light 106 is at least decreased.

It should be understood that the geometry of the display structure 100 illustrated in the embodiment of FIG. 1 is only exemplary and the display structure 100 may be implemented in various other ways. For example, the dimensions of the waveguide 101 and the dimensions of the in-coupling structure 102 and of the polarization manipulating grating 103 have been chosen for illustrative purposes.

According to an embodiment, the in-coupling structure 102 and the polarization manipulating grating 103 are arranged such that, when the polarization-rotated in-coupled light 106 is reflected from the first side 110, the resulting reflected polarization-rotated in-coupled light 107 does not hit the polarization manipulating grating 103.

For example, the embodiment of FIG. 1 illustrates an example of the reflected polarization-rotated in-coupled light 107 not hitting the polarization manipulating grating 103. If the reflected polarization-rotated in-coupled light 107 hits the polarization manipulating grating 103, the polarization may be rotated further, which can cause unwanted out-coupling as the light interacts with the in-coupling structure 102 during subsequent reflections inside the waveguide 101.

According to an embodiment, a surface area of the polarization manipulating grating is less than a surface area of the in-coupling structure.

The surface area and/or positioning of the in-coupling structure 102 and of the polarization manipulating grating 103 can be configured according to optical simulations.

In some embodiments, the display structure 100 may comprise a second waveguide. The second waveguide may comprise a second in-coupling structure on a first side of the second waveguide. The second in-coupling structure may comprise diffractive grating features and sub-wavelength grating features and be configured to receive light passed through the waveguide comprising at least a part of the second polarization. The diffractive grating features of the second in-coupling structure can be configured to couple at least part of the second polarization into the second waveguide as second in-coupled light. The sub-wavelength grating features of the second in-coupling structure can be configured to make the diffractive grating features of the second in-coupling structure at least partially transparent to the first polarization.

The display structure 100 may further comprise a second polarization manipulating grating on a second side of the second waveguide configured to receive at least a part of the second in-coupled light, and to rotate the polarization of the second in-coupled light, resulting in second polarization-rotated in-coupled light, when the second in-coupled light is reflected from the second side of the second waveguide back towards the first side of the second waveguide.

FIG. 2 illustrates a schematic representation of an in-coupling structure according to an embodiment.

According to an embodiment, a structure for in-coupling a first polarization into a waveguide comprises a plurality of diffractive grating lines and a plurality sub-wavelength grating lines and configured to receive light comprising a first polarization and a second polarization, wherein the plurality of diffractive grating lines are configured to couple at least part of the first polarization into the waveguide as in-coupled light, the plurality of sub-wavelength grating lines are configured to make the plurality of diffractive grating lines at least partially transparent to the second polarization, and each grating line in the plurality of diffractive grating lines comprises an air gap.

According to an embodiment, the diffractive grating features comprise a plurality of diffractive grating lines 201 and the sub-wavelength grating features comprise a plurality sub-wavelength of grating lines 202.

According to an embodiment, a grating period of the diffractive grating features is greater than 250 nanometres (nm) and a grating period of the sub-wavelength grating features is less than 250 nanometres.

Alternatively or additionally, the grating period of the diffractive grating features is greater than 260 nm, 270 nm, 280 nm, 290 nm, or 300 nm.

Alternatively or additionally, the grating period of the sub-wavelength grating features is less than 240 nm, 230 nm, or 220 nm.

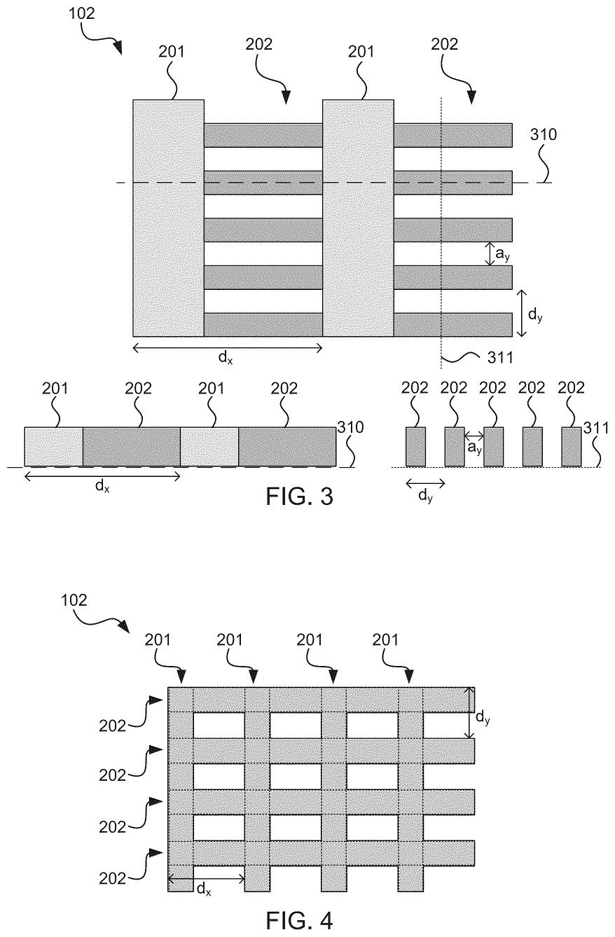

The grating period of the diffractive grating features is denoted by dₓ in the embodiments of FIG. 2, FIG. 3, and FIG. 4.

The grating period of the sub-wavelength grating features is denoted by d_{y} in the embodiments of FIG. 2, FIG. 3, and FIG. 4.

According to an embodiment, a grating period of the diffractive grating features is 300-500 nm.

According to an embodiment, each grating line in the plurality of diffractive grating lines 201 comprises an air gap 203.

According to an embodiment, a width of each air gap 203 in the plurality of diffractive grating lines 201 is 30-100 nm.

The width of the air gap 203 is denoted by aₓ in the embodiment of FIG. 2.

According to an embodiment, the plurality of sub-wavelength grating lines 202 are positioned between the plurality of diffractive grating lines 201.

According to an embodiment, the plurality of diffractive grating lines 201 and the plurality of sub-wavelength grating lines 202 are non-parallel.

For example, in the embodiments of FIG. 2, FIG. 3, and FIG. 4, the plurality of diffractive grating lines 201 and the plurality of sub-wavelength grating lines 202 are non-parallel. For example, the plurality of diffractive grating lines 201 and the plurality of sub-wavelength grating lines 202 may be substantially orthogonal such as in the embodiments of FIG. 2, FIG. 3, and FIG. 4. Alternatively, the plurality of diffractive grating lines 201 and the plurality of sub-wavelength grating lines 202 can be in any other non-parallel orientation.

According to an embodiment, a distance between grating lines in each consecutive grating line pair in the plurality of sub-wavelength grating lines 202 is 60-150 nm.

In the embodiments of FIG. 2 and FIG. 3, the distance between grating lines in each consecutive grating line pair in the plurality of sub-wavelength grating lines 202 is denoted by a_{y}.

According to an embodiment, a width of each grating line in the plurality of sub-wavelength grating lines 202 is 50-160 nm.

According to an embodiment, grating lines in the plurality of diffractive grating lines 201 are substantially parallel with the first polarization.

In the embodiment of FIG. 2, cross-sections of the in-coupling structure 102 along the dashed line 210 and along the dotted line 211 are also illustrated. The first polarization can be along the dotted line 211 and the second polarization can be along the dashed line 210.

Light experiences the sub-wavelength grating features as a birefringent medium. Thus, the effective refractive indices for polarizations along the dashed line 210 and along the dotted line 211 are different. By tuning the dimensions of the subwavelength features, refractive indices can be tuned such that the diffractive grating structure become at least partially transparent to the polarization along the dashed line 210.

In the embodiment of FIG. 2, for example, the diffractive grating features can be made at least partially transparent to the second polarization by tuning aₓ, dₓ, a_{y}, d_{y}, the refractive index of the material of the diffractive grating feature, and/or the refractive index of the material of the sub-wavelength grating feature. Appropriate values for at least some of these parameters can be found using, for example, optical simulations. In some cases, some of these parameters can have predetermined values and the values of the rest of these parameters can be found using optical simulations. For example, the refractive index of the material of the diffractive grating feature, and/or the refractive index of the material of the sub-wavelength grating feature 202 may be pre-determined by the used material(s) and aₓ, dₓ, a_{y} and/or d_{y} can be found using optical simulations.

According to an embodiment, the sub-wavelength grating features are configured to make the diffractive grating features at least partially transparent to the second polarization via a spatial refractive index average along a direction of the second polarization being substantially constant.

According to an embodiment, a refractive index of a material of the diffractive grating features is in the range 1.9-2.4 and a refractive index of a material of the sub-wavelength grating features is in the range 1.9-2.4.

According to an embodiment d_{y} is in the range 200-220 nm, dₓ is in the range 300-500 nm, a_{y} is in the range 60-150 nm, aₓ is in the range 30-100, a refractive index of a material of the diffractive grating features is substantially 2.4, and a refractive index of a material of the sub-wavelength grating features is substantially 2.4.

FIG. 3 illustrates a schematic representation of an in-coupling structure according to another embodiment.

According to an embodiment, a structure for in-coupling a first polarization into a waveguide comprises a plurality of diffractive grating lines and a plurality sub-wavelength grating lines and configured to receive light comprising a first polarization and a second polarization, wherein the plurality of diffractive grating lines are configured to couple at least part of the first polarization into the waveguide as in-coupled light, the plurality of sub-wavelength grating lines are configured to make the plurality of diffractive grating lines at least partially transparent to the second polarization, and the plurality of diffractive grating lines is made of a material with a first refractive index and the plurality of sub-wavelength grating lines is made of a material with a second refractive index different from the first refractive index.

According to an embodiment, the plurality of diffractive grating lines 201 is made of a material with a first refractive index and the plurality of sub-wavelength grating lines 202 is made of a material with a second refractive index different from the first refractive index.

The first refractive index may be denoted by n₁ and the second refractive index may be denoted by n₂.

A refractive index of a material may refer to a refractive index that light experiences when the light interacts with a substantially homogeneous piece of the material. The refractive index of a material may be wavelength dependent. It should be appreciated that an effective refractive index caused by, for example, the sub-wavelength grating features can differ from the refractive index of the material of which the sub-wavelength grating features are made of due to the sub-wavelength grating features having a sub-wavelength size. Since the sub-wavelength grating features have a sub-wavelength size, the light experiences a spatially averaged effective refractive index that depends on the relative orientation of the sub-wavelength grating features and the polarization of the light. Thus, the effective refractive index of the sub-wavelength grating features is anisotropic and polarization dependent.

In the embodiment of FIG. 3, cross-sections of the in-coupling structure along the dashed line 310 and along the dotted line 311 are also illustrated. The first polarization can be along the dotted line 311 and the second polarization can be along the dashed line 310.

Light experiences the sub-wavelength grating features as a birefringent medium. Thus, the effective refractive indices for polarizations along the dashed line 310 and along the dotted line 311 are different. By tuning the dimensions of the subwavelength features, refractive indices can be tuned such that the diffractive grating structure become at least partially transparent to the polarization along the dashed line 310.

In the embodiment of FIG. 3, for example, the diffractive grating features can be made at least partially transparent to the second polarization by tuning dₓ, a_{y}, d_{y}, the refractive index of the material of the diffractive grating features, and/or the refractive index of the material of the sub-wavelength grating feature 202. Appropriate values for at least some of these parameters can be found using, for example, optical simulations. In some cases, some of these parameters can have predetermined values and the values of the rest of these parameters can be found using optical simulations. For example, the refractive index of the material of the diffractive grating feature 201, and/or the refractive index of the material of the sub-wavelength grating feature 202 may be pre-determined by the used material(s) and dₓ, a_{y} and/or d_{y} can be found using optical simulations.

According to an embodiment, each grating line in the plurality of diffractive grating lines comprises an air gap 203, the plurality of diffractive grating lines is made of a material with a first refractive index, and the plurality of sub-wavelength grating lines 202 is made of a material with a second refractive index different from the first refractive index. Thus, the embodiments of FIG. 2 and FIG. 3 may be combined into another embodiment.

FIG. 4 illustrates a schematic representation of an in-coupling structure according to another embodiment.

According to an embodiment, a structure for in-coupling a first polarization into a waveguide comprises a plurality of diffractive grating lines and a plurality sub-wavelength grating lines and configured to receive light comprising a first polarization and a second polarization, wherein the plurality of diffractive grating lines are configured to couple at least part of the first polarization into the waveguide as in-coupled light, and the plurality of sub-wavelength grating lines are configured to make the plurality of diffractive grating lines at least partially transparent to the second polarization.

In the embodiment of FIG. 4, the plurality of diffractive grating lines 201 and the plurality of sub-wavelength grating lines 202 are made of the same material. For example, the plurality of diffractive grating lines 201 and the plurality of sub-wavelength grating lines 202 can be made of titanium dioxide (TiO₂). The refractive index of TiO₂ is approximately 2.4. The space between the plurality of diffractive grating lines 201 and the plurality of sub-wavelength grating lines 202 can be, for example, air.

Similarly to the embodiments of FIG. 2 and FIG. 3, the polarization parallel with the diffractive grating lines 201 experiences the diffractive grating features as a diffractive grating. Thus, the polarization parallel with the diffractive grating lines 201 can be coupled into the waveguide 101 using diffraction. Similarly, the sub-wavelength grating lines 202 are sub-wavelength, the polarization parallel with the sub-wavelength grating lines 202 experiences a spatially averaged refractive index caused by the sub-wavelength grating features and the material between the sub-wavelength grating features, such as air. This average refractive index can be tuned such that it sufficiently matches the refractive index of the material of the diffractive grating features. Thus, the diffractive grating features can be made at least partially transparent to the second polarization.

According to an embodiment, a width of each grating line in the plurality of diffractive grating lines 201 is 80 nm and a width of each grating lines in the plurality of sub-wavelength grating lines 202 is 80 nm.

According to an embodiment, a grating period dₓ is in the range 300-400 nm.

According to an embodiment, a grating period d_{y} is in the range 150-200 nm.

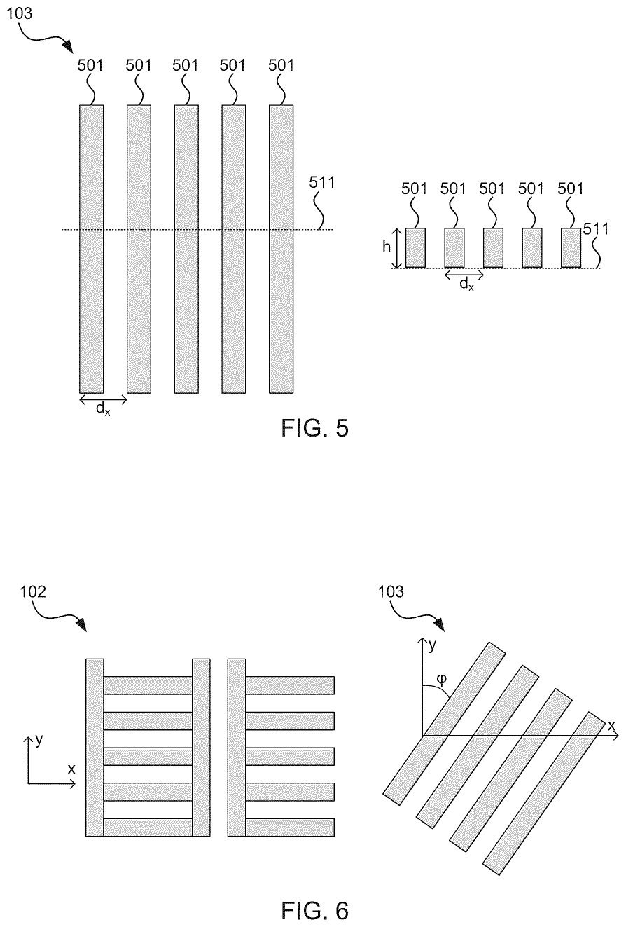

FIG. 5 illustrates a schematic representation of a polarization manipulating grating according to an embodiment.

According to an embodiment, the polarization manipulating grating 103 comprises a plurality of polarization manipulating grating lines 501 that are non-parallel with the plurality of diffractive grating lines 201.

According to an embodiment, the polarization manipulating grating 103 comprises a sub-wavelength polarization manipulating grating.

According to an embodiment, a grating period of the polarization manipulating grating is less than 250 nanometres.

For example, the sub-wavelength polarization manipulating grating can be made of TiO₂. The space between sub-wavelength polarization manipulating grating can be, for example, air.

The embodiment of FIG. 5 illustrates an example of a polarization manipulating grating 103 comprising a plurality of sub-wavelength polarization manipulating grating lines 501. The grating period of the polarization manipulating grating 103 is denoted by dₓ and the height of each grating line in the plurality of sub-wavelength polarization manipulating grating lines 501 is denoted by h. A cross section along the dotted line 511 is also illustrated.

According to an embodiment, a width of each grating line in the sub-wavelength polarization manipulating grating can be 70 nm.

According to an embodiment a grating period dₓ of the sub-wavelength polarization manipulating grating is in the range 100-160 nm. A width of each grating line in the sub-wavelength polarization manipulating grating can be 50-80 nm.

According to an embodiment a height h of the sub-wavelength polarization manipulating grating is in the range 100-250 nm.

In the embodiment of FIG. 5, for example, the polarization manipulating grating 103 can be configured to rotate the polarization of the in-coupled light 105 by tuning h, dₓ, the width of the sub-wavelength polarization manipulating grating lines 501, and/or the refractive index of the sub-wavelength polarization manipulating grating lines 501. Appropriate values for at least some of these parameters can be found using, for example, optical simulations. In some cases, some of these parameters can have predetermined values and the values of the rest of these parameters can be found using optical simulations. For example, the refractive index of the material of the sub-wavelength polarization manipulating grating lines 501 may be pre-determined by the used material(s).

According to an embodiment, the polarization manipulating grating 103 comprises a one-dimensional the polarization manipulating grating.

The embodiment of FIG. 5 is only an example of the polarization manipulating grating 103 and the polarization manipulating grating 103 may also be implemented in various other ways. For example, in some embodiments the polarization manipulating grating 103 may comprise a slanted grating.

FIG. 6 illustrates a schematic representation of rotation between an in-coupling structure and a polarization manipulating grating according to an embodiment.

According to an embodiment, the plurality of diffractive grating lines of the in-coupling structure 102 and the plurality of polarization manipulating grating lines of the polarization manipulating grating 103 are non-parallel.

For example, in the embodiment of FIG. 6, the plurality of polarization manipulating grating lines of the polarization manipulating grating 103 are rotated by an angle φ in relation to the plurality of diffractive grating lines of the in-coupling structure 102.

The rotation angle between the plurality of diffractive grating lines of the in-coupling structure 102 and the plurality of polarization manipulating grating lines of the polarization manipulating grating 103 can be found using optical simulations. For example, the angle «can be set by minimizing unwanted out-coupling of the polarization-rotated in-coupled light 106.

According to an embodiment, the in-coupling structure 102 comprises a plurality of sections, wherein for each section in the plurality of section, a rotation angle between the section and the polarization manipulating grating 103 is different. The rotation angle can be measured, for example, between the plurality of diffractive grating lines of each section and the plurality of polarization manipulating grating lines of the polarization manipulating grating 103.

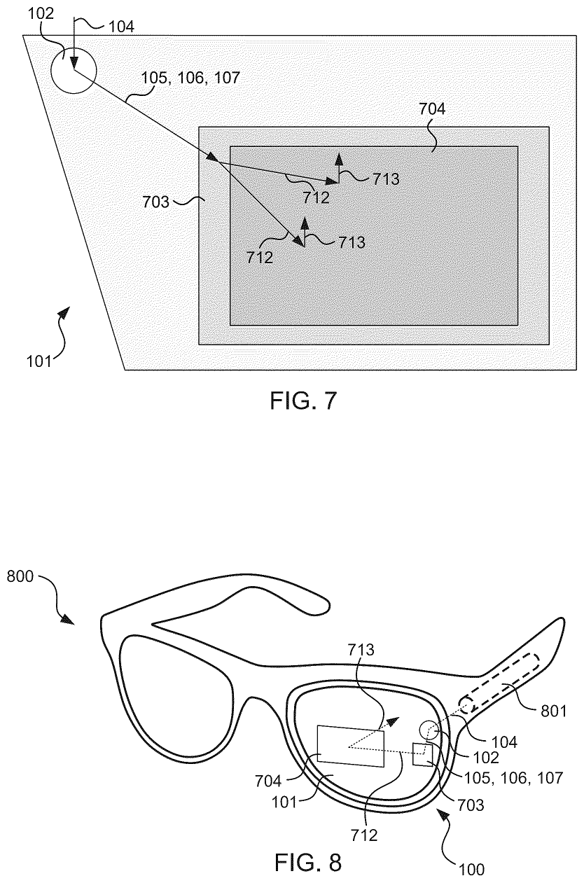

FIG. 7 illustrates a schematic representation of a waveguide according to an embodiment.

The in-coupling structure 102 can couple at least part of the first polarization into the waveguide as the in-coupled light 105. The polarization manipulating grating 103 can receive at least a part of the in-coupled light 105 and rotate the polarization of the in-coupled light 105, resulting in the polarization-rotated in-coupled light 106. The polarization-rotated in-coupled light 106 can be reflected from the first side 110, the resulting reflected polarization-rotated in-coupled light 107. Thus, the light can be guided in the waveguide 101 via TIR.

The waveguide 101 may further comprise an exit pupil expansion (EPE) structure 703 configured to receive the light guided inside the waveguide 101 and to diffract the light in a plurality of directions, producing a set of diffracted beams 712.

It should be appreciated that the set of diffracted beams 712 illustrated in the embodiment of FIG. 7 are only illustrative. In practical embodiments, the EPE structure 703 can diffract the set of in-coupled beams in a plurality of directions in a much more complex manner and the set of diffracted beams 712 can interact with the EPE structure 703 a plurality of times.

The display structure 100 may further comprise an out-coupling structure 704 configured to receive, from the EPE structure 703, at least the set of diffracted beams 712 and to out-couple at least the set of diffracted beams 712 from the planar waveguide 101 as a set of output beams 713.

The set of output beams 713 may represent, for example, an expanded version of the image formed by the light 104.

The in-coupling structure 102, the EPE structure 703 and/or the out-coupling structure 704 may comprise, for example, a diffractive grating on a surface of the waveguide 101. The in-coupling structure 102 may couple the light 104 into the waveguide 101 via diffraction. The EPE structure 703 may expand the image corresponding to the in-coupled light 105 via diffraction. The out-coupling structure 704 may out-couple the set of diffracted beams 712 from the waveguide 101 via diffraction.

FIG. 8 illustrates a schematic representation of a display device according to an embodiment.

According to an embodiment, a display device 800 comprises the display structure 100.

According to an embodiment, the display device 800 further comprises an optical engine 801 for directing the light 104 to the in-coupling structure 102.

According to an embodiment, the display device 800 is implemented as a see-through display device.

According to an embodiment, the display device 800 is implemented as a head-mounted display device.

For example, in the embodiment of FIG. 8, the display device 800 is implemented as smart glasses. The waveguide 101 can correspond to a layer of a lens of such smart glasses. Such smart glasses may be used to, for example, implement augmented reality (AR), virtual reality (VR), and/or extended reality (XR) functionality.

In the embodiment of FIG. 8, the light 104 may be generated by, for example, an optical engine 801, such as a scanner-based optical engine. The light 104 may represent an image generated by, for example, such an optical engine. The display structure 100 of the display device 800 can direct the set of output beams 713 representing the image generated by the optical engine 801 into the eye of a user.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A display structure comprising:
a waveguide
an in-coupling structure on a first side of the waveguide comprising diffractive grating features and sub-wavelength grating features, and configured to receive light comprising a first polarization and a second polarization, wherein the diffractive grating features are configured to couple at least part of the first polarization into the waveguide as in-coupled light and wherein the sub-wavelength grating features are configured to make the diffractive grating features at least partially transparent to the second polarization; and
a polarization manipulating grating on a second side of the waveguide configured to receive at least a part of the in-coupled light, and to rotate the polarization of the in-coupled light, resulting in polarization-rotated in-coupled light, when the in-coupled light is reflected from the second side of the waveguide back towards the first side of the waveguide;
wherein the diffractive grating features comprise a plurality of diffractive grating lines and the sub-wavelength grating features comprise a plurality sub-wavelength grating lines, the plurality of sub-wavelength grating lines are positioned between the plurality of diffractive grating lines, and the plurality of diffractive grating lines and the plurality of sub-wavelength grating lines are non-parallel.

2. The display structure according to claim 1, wherein the in-coupling structure and the polarization manipulating grating are configured such that the diffractive grating features are at least partially transparent to the polarization-rotated in-coupled light.

3. The display structure according to claim 1, wherein grating lines in the plurality of diffractive grating lines are substantially parallel with the first polarization.

4. The display structure according to claim 1, wherein each grating line in the plurality of diffractive grating lines comprises an air gap.

5. The display structure according to claim 1, wherein the plurality of diffractive grating lines is made of a material with a first refractive index, and the plurality of sub-wavelength grating lines is made of a material with a second refractive index different from the first refractive index.

6. The display structure according to claim 1, wherein the polarization manipulating grating comprises a plurality of polarization manipulating grating lines that are non-parallel with the plurality of diffractive grating lines.

7. The display structure according to claim 1, wherein the polarization manipulating grating comprises a sub-wavelength polarization manipulating grating.

8. The display structure according to claim 1, wherein a surface area of the polarization manipulating grating is less than a surface area of the in-coupling structure.

9. The display structure according to claim 1, wherein the in-coupling structure and the polarization manipulating grating are arranged such that, when the polarization-rotated in-coupled light is reflected from the first side, the resulting reflected polarization-rotated in-coupled light does not hit the polarization manipulating grating.

10. The display structure according to claim 1, wherein a grating period of the diffractive grating features is greater than 250 nanometres, a grating period of the sub-wavelength grating features is less than 250 nanometres, and/or a grating period of the polarization manipulating grating is less than 250 nanometres.

11. The display structure according to claim 1, wherein the first polarization and the second polarization are substantially orthogonal.

12. A display device comprising the display structure according to any claim 1.

13. A structure for in-coupling a first polarization into a waveguide, the structure comprising a plurality of diffractive grating lines and a plurality sub-wavelength grating lines and configured to receive light comprising a first polarization and a second polarization, wherein the plurality of diffractive grating lines are configured to couple at least part of the first polarization into the waveguide as in-coupled light, the plurality of sub-wavelength grating lines are configured to make the plurality of diffractive grating lines at least partially transparent to the second polarization, each grating line in the plurality of diffractive grating lines comprises an air gap, the plurality of sub-wavelength grating lines are positioned between the plurality of diffractive grating lines, and the plurality of diffractive grating lines and the plurality of sub-wavelength grating lines are non-parallel.
